(19) United States
(12) Patent Application Publication
(10) Pub. No.: US 2006/0083371 A1
(43) Pub. Date: Apr. 20, 2006

(54) Management messages transmission method by a management center intended to a plurality of multimedia units

(76) Inventors: Gregory Duval, La Conversion (CH); Jimmy Cochard, Attalens (CH); Henri Kudelski, Grandvaux (CH); Paul-Jean Cagnard, Lausanne (CH); Patrick Hauert, Pully (CH)

Correspondence Address: HARNESS, DICKEY & PIERCE, P.L.C., P.O. BOX 8910, RESTON, VA, 20195, US

(21) Appl. No.: 11/247,224

(22) Filed: Oct. 12, 2005

(30) Foreign Application Priority Data
Oct. 15, 2004 (EP) EP 04105093.1

(51) Int. Cl. H04L 9/28

(52) U.S. Cl. 380/28

(57) ABSTRACT

The present invention relates to a management messages transmission method by a management center intended to a plurality of multimedia units. Each unit has a security module (SC) comprising at least one global encryption key used in relation with an encryption module. This method is characterized in that it consists of dividing the totality of the security modules allowing access to encrypted data originating from a determined provider into at least two groups (GR1, GR2), a first group of security modules having a first configuration of the security elements and a second group of security modules having a second configuration of the security elements, the first configuration being different from the second configuration.

### PRIORITY STATEMENT

This U.S. non-provisional application claims benefit of priority under 35 U.S.C. §119 of European Patent Application No. 04105093.1, filed on Oct. 15, 2004, the entire contents of which are incorporated herein by reference.

### TECHNICAL FIELD

The present invention relates to a management messages transmission method by a management center intended to a plurality of multimedia units.

### BACKGROUND ART

In the field of conditional access data management, in particular in the field of Pay-TV, access to data broadcasted by a data provider is subjected to the acquirement of rights. These rights are sent in entitlement management messages EMM. The access to data is generally subjected to obtaining keys that are generally control words CW sent in the form of management messages ECM. The presence of a right for each subscriber and each event is verified by means of a security module.

As it is well known from the man skilled in the art, the security module can essentially be realised according to four distinct forms. One of these forms is a microprocessor card, a smart card, or more generally an electronic module (taking the form of key, a badge, . . . ). Such a module is generally removable and connectable to the decoder. The form with electric contacts is the most widely used, but a connection without contact for example of the type ISO 14443 is not excluded.

A second known form is that of an integrated circuit box, generally placed definitively and irremovably in the decoder. An alternative is made up of a circuit mounted on a base or connector such as a SIM module connector.

In a third form, the security module is integrated into an integrated circuit box also having another function, for example in a descrambling module of the decoder or in the microprocessor of the decoder.

In a fourth embodiment, the security module is not realised as a hardware, but its function is implemented only in software form. Given that in the four cases, the function is identical although the security level differs, we can talk about a security module regardless of the way in which its function is carried out or the form that this module may take.

According to the increasingly important development of Pay-TV systems and due to the increase in the number of subscribers to the same data provider, the interest in breaking the security of a security module and consequently the risk that the security is actually broken is increasingly important. The knowledge of the secrets contained in a security module allows falsified modules, or clone modules to be produced which can be sold and which allow access to data without having to acquire the corresponding rights. In fact, a falsified module skips the verification step of the rights carried out in a conventional module. Instead, it carries out the processing of management messages ECM in order to extract the control words and thus be able to access data in the same way as a conventional module.

In the systems of the prior art, when the system's security has been broken and falsified modules have been distributed, it can become necessary, when the quantity of clone modules in circulation becomes too large and when important financial losses are the result, to replace the totality of the security modules in service for a determined provider. This requires a very long time and results in very heavy expenses.

The patent application published under the number WO 03/061289 describes a process in which decoders of different origins have access to encrypted data. The aim of this process is to prevent having to encrypt the same content several times with different encryption means so that all the decoders of a disparate decoder park can access the content.

According to this invention, one part of the content, for example the video part of an audio/video content is sent in clear. The audio part is encrypted according to the different encryption methods compatible with the decoders of the decoder park. This data is thus sent several times, in several different encryption formats.

Therefore, this invention is not foreseen to process an entirely encrypted content. This creates a security problem since one part of the content is not entirely encrypted.

It should also be noted that this document indicates that decryption is carried out in a decoder. It does not mention the possible existence of security modules responsible for cryptographic operations.

Once a decoder has allowed the production of clones or once the security connected to a content provider has been broken, it is advisable to change the access means to the content. In the case where decryption is carried out by the decoder, this involves the change of all the decoders that allow access to the content broadcasted by the provider whose security has been broken.

In the case where decryption is carried out by means of a security module, this involves the replacement of all the security modules allowing access to the content of this provider.

In both cases, this replacement operation is not possible for a provider when the number of clones in circulation is notable and the loss of earnings are significant.

The process described in this document WO 03/061289 does not allow the replacement of only one part of the decoders providing access to an encrypted content made available by a content provider. In fact, if access to the content by clone decoders is to be prevented, it is necessary to change all the decoders that allow access to this content.

It should be noted that the process of the invention described in WO 03/061289 aims to respond to a need that is imposed by historical circumstances having led to the formation of the concerned decoder park. In fact, the existence of different types of decoders, having different requirements and demands with respect to access to data makes it necessary to broadcast contents in accordance with these requirements.

Given that the need is imposed by the circumstances, it is not possible to form groups by selecting a particular parameter, but only by undergoing the constraints due to the heterogeneity of the decoders.

Another impact is that the messages intended to allow access to the same content by two different types of decoders do not have any common part when they are encrypted. This results in a relatively complex management of the messages.

### DISCLOSURE OF THE INVENTION

This invention intends to overcome the drawbacks of the devices in the prior art by providing a system and a method in which the knowledge of the secrets of a security module do not allow the secrets of all the modules to be known. This means that in the case of security module cloning that allows unauthorized access to content made available by a content provider, it is not necessary to replace all the security modules linked to this provider, but only a part of them.

According to this invention, it is moreover possible to form groups of security modules by imposing a parameter common to members of this group. Furthermore, it is possible to use common elements between the security module groups, which can simplify the management of the messages.

These objects are achieved by a management messages transmission method by a management center intended to a plurality of multimedia units, each unit having a security module comprising at least one global encryption key used in relation with an encryption module, characterized in that it consists of dividing the totality of the security modules allowing access to encrypted data originating from a determined provider into at least two groups, a first group of security modules having a first configuration of the security elements and a second group of security modules having a second configuration of the security elements, the first configuration being different from the second configuration.

According to the invention, diversifying the security modules on the material level is proposed, namely, for one data provider, one disposes of security modules having different initial configurations. These configurations can in particular be specific global keys, keys of a particular length, particular encryption modules or algorithms, messages of different formats, . . .

Thanks to this system, when the security of a security module has been broken and the keys are thus known, it is possible to replace only the modules belonging to the same group as the broken module. Therefore, only a determined part of the security modules must be replaced.

### BRIEF DESCRIPTION OF THE DRAWINGS

This invention and its advantages will be better understood with reference to the enclosed Figures and the detailed description of particular embodiments, in which:

FIG. 1 schematically illustrates the system assembly for implementing the method of the invention;

FIG. 2 represents a first entitlement control message format of the type that can be used in the method of the invention;

FIGS. 3 and 4 represent other entitlement control message formats which can be used in the invention;

FIG. 5 schematically illustrates entitlement management messages and entitlement control messages according to this invention;

FIG. 6 schematically illustrates a variant of the type of entitlement management messages and entitlement control messages used in this invention.

### MODES FOR CARRYING OUT THE INVENTION

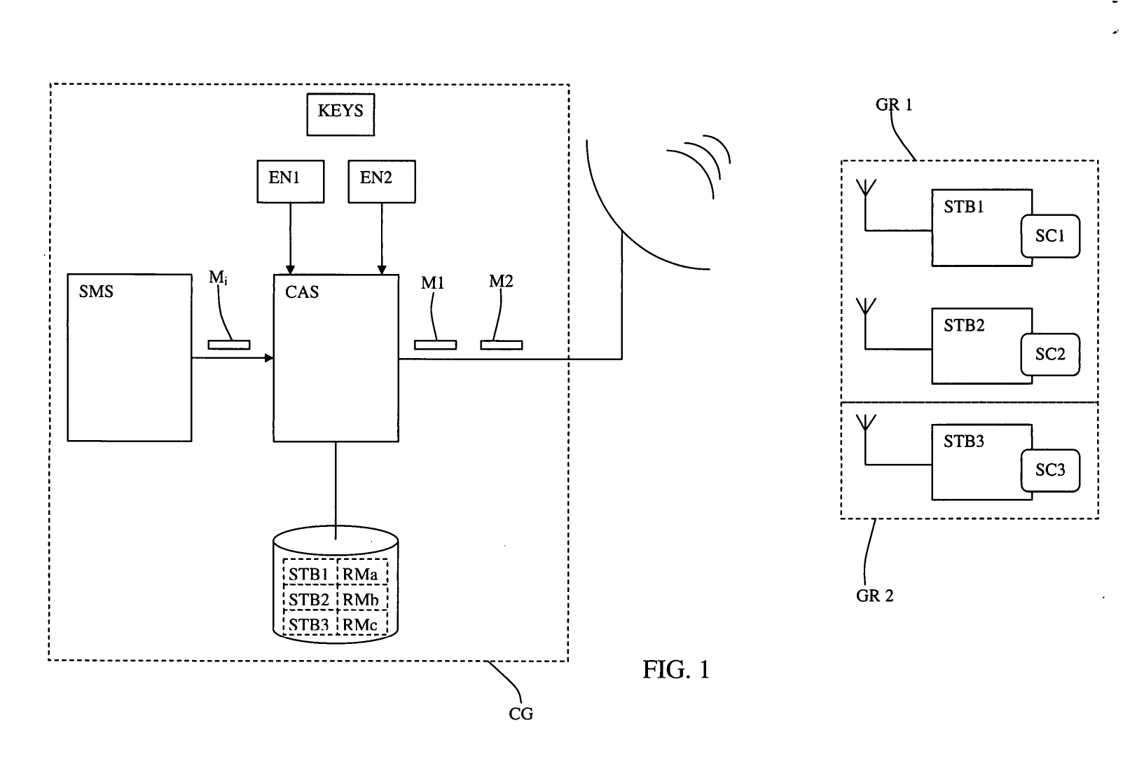

With reference to FIG. 1, the system for implementing the method of the invention includes a management centre CG responsible for managing a plurality of multimedia units, these multimedia units including a STB decoder, a security module SC and message reception means.

As it is well known, the management centre CG is responsible for sending entitlement management messages EMM and entitlement control messages ECM in particular. These messages are transmitted by transmission means and are called management messages. As it is well known, the entitlement control messages ECM contain in particular one or more control words CW that allow the decryption of the encrypted data. These entitlement control messages are encrypted by means of a transmission key.

The transmission key is sent to the concerned security modules in entitlement management messages EMM themselves encrypted by means of a global key.

In the illustrated example, the management centre manages three multimedia units distributed in two groups. In practice, a management centre can be responsible for several hundreds of thousands of multimedia units, even several million. According to the invention, the latter can be distributed in a number of groups that varies between two and around twenty. The upper limit is not technically defined, but a number of groups that is too large renders the management of the messages difficult. The security modules of the groups represented allow all the access to data transmitted by one data provider.

These groups are defined by the provider, the management centre or the security module manufacturer, for example, and can be formed according to parameters selected by the organism responsible for the formation of the groups. The parameters used can in particular be security module serial numbers, zip codes or manufacturing dates of the modules.

The multimedia units of the first group GR1 use an initial configuration different from the configuration of the units of the second group GR2. This configuration can be one or more of the following elements:
Global key, key length, encryption module or algorithm, message format.

Preferably, the security level of each configuration is roughly equal. It should be noted that a security module can, for example, initially be realised in order to be able to belong to any group. Belonging to a determined group can be carried out, for example, after the installation of the security module in a decoder of a buyer, by eliminating the interpretation means of the messages intended for other groups that the one that has been chosen for this security module. In particular, this allows a security module to be linked to the zip code of a buyer.

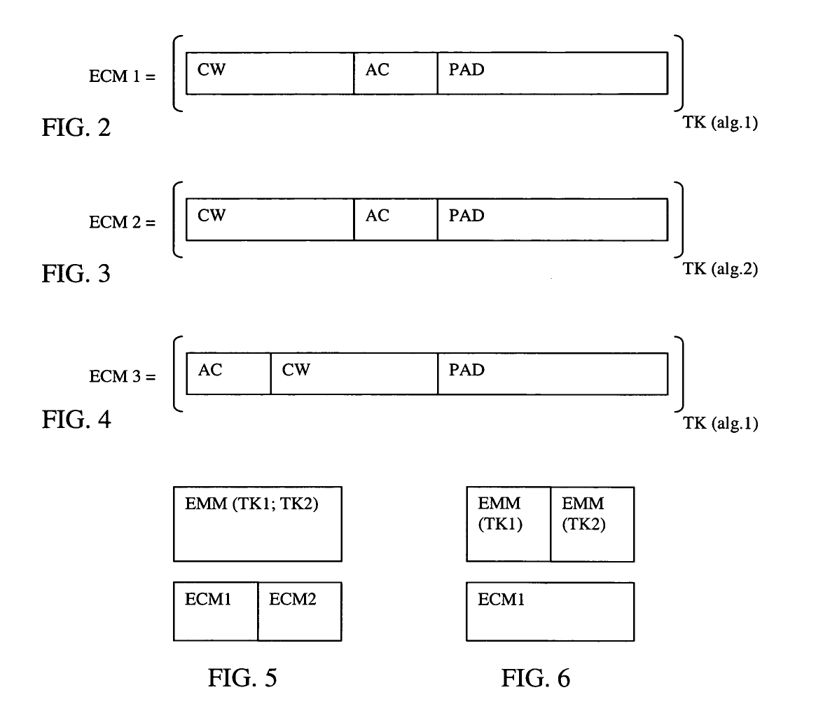

As an example, the process of the invention is described with reference to FIGS. 2 to 4. According to a first embodiment, entitlement control messages ECM can be sent to two different groups according to the formats illustrated by FIGS. 2 and 3. In FIG. 2, the entitlement control message ECM 1 contains a control word CW, access conditions AC to a determined content, possibly other non-represented fields and a filling value PAD which can, for example, be a random value or a fixed preset value. The content of these fields is encrypted by means of a transmission key TK using a first encryption algorithm called alg. 1.

With reference to FIG. 3, an entitlement control message ECM 2 intended for the second user group GR2 contains the same fields as previously, that is to say a control word CW, the access conditions AC and the filling value PAD. It should be noted that this filling value can be identical to that of the entitlement control message ECM 1 or on the contrary it can be different. The content of these fields is encrypted by means of the same transmission key TK as the entitlement control message ECM 1, but by means of a different encryption algorithm alg. 2. Usable encryption algorithms are well known and can be, for example, DES, IDEA, 3-DES, AES.

In the case explained above, the messages have a common part which is on the one hand their content in clear and on the other hand, the transmission key.

According to a second embodiment, entitlement control messages ECM can be sent to two different groups according to the formats illustrated by FIGS. 2 and 4. The content of the entitlement control message ECM 1 has been detailed above. The entitlement control message ECM 3, illustrated in FIG. 4 contains the same fields as previously, that is to say a control word CW, the access conditions AC and the filling value PAD, but they are not placed in the same order as previously. The access conditions can, for example, appear first, the control word second and the filling value third. It is clear that an indication must also appear in the entitlement control message or in another place indicating the order of the fields. The values contained in these fields are encrypted by a transmission key and an algorithm that can be the same as those used in the case of the first entitlement control message ECM 1. In this case, the common part between the entitlement control messages sent to the decoder groups is formed with the content of the message, the transmission key and the encryption algorithm. It is only the order of the content of the messages that changes.

A combination of two previous embodiments can also be realized. In this combination, the order of the fields is different between the two messages and the algorithm for encrypting the messages of two different groups is also different.

FIG. 5 shows an embodiment of the process in which the entitlement management messages EMM are common to members of different groups of security modules. These entitlement management messages contain transmission keys TK1, TK2 associated to different groups of security modules. In the represented case, different entitlement control messages ECM are sent to different security modules of different groups, the messages intended for one of the groups being encrypted by means of a first transmission key TK1 and the messages of the other security module group being encrypted by means of another transmission key TK2.

FIG. 6 shows another variant “opposite” to that of FIG. 5. In fact, according to this variant, the entitlement control messages ECM are common to the different groups of concerned multimedia units. The entitlement management messages EMM are different for each multimedia unit group. These messages can be different at the level of the used encryption algorithm, of the key, in value and/or in length, or at the level of the formatting of the contents in particular. The rights transmitted with these entitlement management messages EMM are different for each group of security modules. This embodiment presents the advantage that the entitlement control messages, which are those requiring the largest bandwidth, are common to several groups of security modules or to all the groups. In the contrary, the entitlement management messages, which require a smaller bandwidth, are different for the different security module groups.

In practice, the messages, and in particular the entitlement control messages ECM, are sent to some multimedia units of the first group GR1 as well as to multimedia units of the second group GR2.

For each multimedia unit to which the message must be sent, the management centre determines, according to a table stored in this centre, which is the initial configuration of the concerned multimedia unit. It then determines the keys to be used for each multimedia unit. The key in question is then introduced into a corresponding encryption module EN, in such a way as to encrypt the entitlement management messages EMM. This is represented in particular by FIG. 1.

If in the considered example, two different global keys, with different lengths are used in two different encryption modules, it is clear that the same initial entitlement management message M1 will produce two encrypted messages M1, M2, different in their contents and also in their length. It should be noted that, as previously indicated, the encryption modules can use different encryption algorithms. The messages resulting from this processing will then be transmitted to the concerned multimedia units by transmission means.

Each multimedia unit group disposes of data pertaining to it, in such a way that a multimedia unit of a given group is in position to decrypt and to process a message which is intended for this group but it will not be capable of processing a message for another group.

When the security of a security module has been broken and that clone modules are circulating in a given group, it is possible to provide subscribers having this type of module with a new module having an initial configuration from another already existing group or a new initial configuration, and then not to use the configuration of the group containing the clone modules. Therefore, the subscribers actually having the acquired rights do not suffer from negative consequences while the users of clone modules can no longer gain access to data.

This method presents the advantage that it is not necessary to replace the totality of the security modules when one or more clones are detected. Only the group containing the clones must be replaced. This simplifies considerably the module changes and also allows a notable reduction of costs connected to this type of change. This also has the consequence that it is interesting modify the configuration of a group as soon as a relatively low number of clone modules is detected or as soon as a relatively low number of clone modules is detected.

1. Management messages transmission method by a management center intended to a plurality of multimedia units, each unit having a security module comprising at least one global encryption key used in relation with an encryption module, wherein the method consists of dividing the totality of the security modules allowing access to encrypted data originating from a determined provider into at least two groups, a first group of security modules having a first configuration of the security elements and a second group of security modules having a second configuration of the security elements, the first configuration being different from the second configuration.

2. Management messages transmission method according to claim 1, wherein said configurations have equivalent security levels.

3. Management messages transmission method according to claim 1, wherein said configurations comprise a specific global key pertaining to each configuration.

4. Management messages transmission method according to claim 1, wherein said configurations comprise a key of specific length pertaining to each configuration.

5. Management messages transmission method according to claim 1, wherein said configurations comprise a specific encryption algorithm pertaining to each configuration.

6. Management messages transmission method according to claim 1, wherein said configurations are defined by a specific message format.

7. Management messages transmission method according to claim 1, wherein it comprises a step of determining to which group the multimedia unit to which a message is transmitted belongs, a step of determining the configuration of this group, a step of preparing a management message using said configuration and a step of transmitting the management message prepared in this way.

8. Management messages transmission method according to claim 1, wherein said security module is removable.

9. Management messages transmission method according to claim 1, wherein the management messages comprise entitlement management messages and entitlement control messages, and in that the entitlement control messages are common to at least two groups of security modules and in that the entitlement management messages are formatted according to each group of security module.

10. Management messages transmission method according to claim 1, wherein the management messages are encrypted by means of an encryption algorithm common to at least two groups of security modules.

11. Management messages transmission method according to claim 1, wherein the management messages are encrypted with a key common to at least two groups of security modules and by means of an encryption algorithm common to said groups of security modules, the content in clear of the management messages of these groups being placed in a different order in the management messages of these groups.

12. Management messages transmission method according to claim 1, wherein the management messages comprise at least two different transmission keys intended for security modules of different groups, these management messages being common to at least two different groups of security modules.

13. Management messages transmission method according to claim 1, wherein the groups of security modules are constituted on the basis of the value of a parameter selected by the management centre.

14. Management messages transmission method according to claim 13, wherein said parameter is selected from among an identification number of the security module, a zip code associated to said security module or a manufacturing date of the security module.
